(19) United States
(12) Patent Application Publication
(10) Pub. No.: US 2008/0011553 A1
(43) Pub. Date: Jan. 17, 2008

(54) BATTERY PACK FOR AN INDUSTRIAL TRUCK

(75) Inventor: Thomas Mielke, Hamburg (DE)

Correspondence Address: VIDAS, ARRETT & STEINKRAUS, P.A., SUITE 400, 6640 SHADY OAK ROAD, EDEN PRAIRIE, MN, 55344, US

(73) Assignee: Jungheinrich Aktiengesellschaft, Hamburg (DE)

(21) Appl. No.: 11/763,573

(22) Filed: Jun. 15, 2007

(30) Foreign Application Priority Data
Jun. 30, 2006 (DE) 10 2006 030 770.4

(51) Int. Cl. B66F 9/075

(52) U.S. Cl. 187/222

(57) ABSTRACT

Battery pack for an industrial truck with an elongate battery box for accommodating a plurality of battery cells, the longitudinal extension thereof extending transversely to the longitudinal axis of the industrial truck, the battery box having a U-shape and a housing for a charging unit being arranged between the arms of the U-shaped battery box.

### CROSS-REFERENCE TO RELATED APPLICATIONS

Not applicable.

### STATEMENT REGARDING FEDERALLY SPONSORED RESEARCH

Not applicable.

### BACKGROUND OF THE INVENTION

The battery pack of battery-operated industrial trucks is arranged at suitable locations on the industrial truck. It comprises a generally elongate battery box which accommodates a plurality of cells, the size of the box and/or the number of cells being dependent on the required amount of energy to be provided and/or on the time period in which energy has to be provided. In so-called reach fork-lift trucks, the battery box is arranged between the cab and the retractable mast. In three- or four-wheeled counterweight forklifts, the battery box is arranged between the axles. In this case, the battery box also serves as a counterweight, together with a weight arranged at the rear of the vehicle.

Discharged batteries naturally have to recharged. This takes place by removing the battery box and transporting to a charging station, whilst the industrial truck is provided with a newly charged battery. This method is relatively costly. A battery pack has become known from DE 102 41 083 A1, the entire contents of which is incorporated herein by reference, in which a battery box accommodates a plurality of battery cells as well as a charging unit. By means of the on-board charging unit, the necessity of changing the battery for charging purposes is dispensed with. Until now, however, so-called on-board chargers have not been known in reach fork-lift trucks and three- or four-wheeled forklifts, as sufficient space is not present therefor in the vehicle.

A battery box for tiller-steered industrial trucks has become known from DE 195 05 456 A1, the entire contents of which is incorporated herein by reference, which comprises at least two portions of different measurements in the longitudinal direction of the vehicle, the portion of the battery box substantially on the drive side in the longitudinal direction of the vehicle being of smaller size than the portion of the battery box substantially located on the other side of the longitudinal centre plane of the industrial truck. The main direction of extension of the known battery pack is transverse to the longitudinal axis of the industrial truck.

The object of the invention is to provide a battery pack for an industrial truck, in particular for a reach fork-lift truck or a three- or four-wheeled counterweight forklift, which leaves space for a charging unit.

### BRIEF SUMMARY OF THE INVENTION

In the battery pack for industrial trucks according to the invention, the battery box is of U-shaped configuration and a housing for a charging unit is arranged between the arms of the U-shaped battery box. Preferably the space between the arms and the housing is formed such that it is accommodated in a manner which fits approximately between the arms and the crosspiece of the battery box. According to one embodiment of the invention, the charging unit may be releasably connected to the battery box in order to form a unit therewith. Thus the battery box is able to be inserted together with the charging unit into the industrial truck and/or removed therefrom.

The U-shape of the battery pack allows a symmetrical arrangement and thus an evenly distributed weight in the industrial truck, which assists the tilt resistance. The shape of the battery pack allows the arrangement of a charging unit on board the industrial truck, the charging unit and battery being able to form—as mentioned—a rigid unit. The outer contour of the battery box and charging unit may coincide with the contour of conventional battery housings in the industrial truck, so that even units which have already been produced may be equipped with the unit according to the invention. The space taken up by the charging unit reduces the battery capacity. This loss may be at least partially compensated for by battery cells of greater height being used. Cells of the standard PzS type are of standard height. However, there are also taller battery cells of the PzB type. These may be used in an advantageous manner. Moreover, by the use of an on-board charging unit it is possible to charge the battery, with a more rapid replacement, by means of partial or complete charging, provided that a power supply is available.

In conventional industrial trucks, the battery also serves as part of the counterweight. The design of the battery pack according to the invention naturally reduces its total weight. Thus according to one embodiment of the invention it may be provided to accommodate one respective weight in the arms of the U-shaped battery box.

According to a further embodiment of the invention, it is provided that the battery box is provided with heat dissipation means. These heat dissipation means may be provided, in particular, in the region of the charging unit, in which the battery box functions for example as a cooling element.

The invention is to be described in more detail hereinafter with reference to an embodiment shown in a drawing.

### BRIEF DESCRIPTION OF THE DRAWING

FIG. 1 shows the plan view of a battery pack according to the invention.

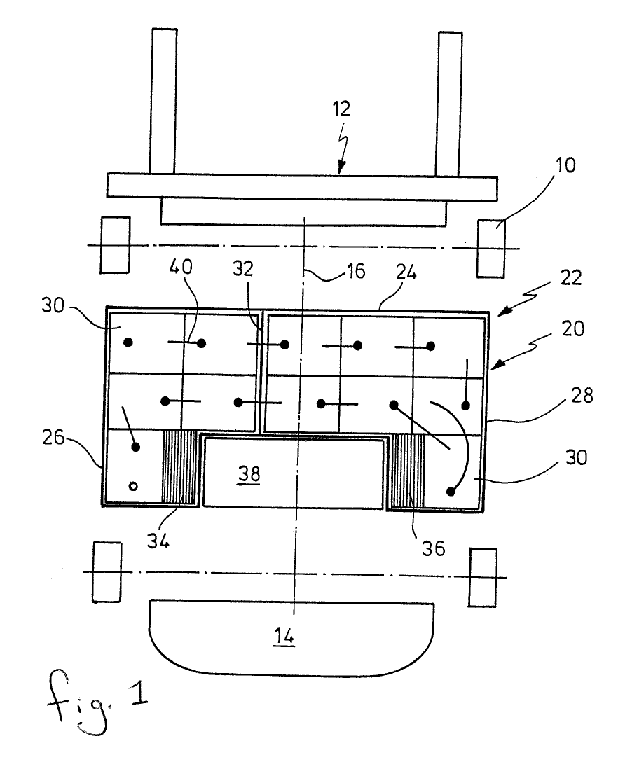

### DETAILED DESCRIPTION OF THE INVENTION

While this invention may be embodied in many different forms, there are described in detail herein a specific preferred embodiment of the invention. This description is an exemplification of the principles of the invention and is not intended to limit the invention to the particular embodiment illustrated

An industrial truck is indicated in the form of a counterweight forklift in plan view in the Figure, the four wheels 10 indicating a four-wheeled chassis; moreover, a lifting mast 12 as well as a counterweight 14 on the rear are indicated on the end of the industrial truck opposing the lifting mast 12. The longitudinal axis of the industrial truck is denoted by 16.

A battery pack 20 is arranged between the wheel axles symmetrically to the axis 16, for driving the industrial truck via a drive motor which is, however, not shown. The battery pack 20 is accommodated in a suitable manner in a battery housing of the industrial truck and preferably pushed in from the side. This is, however, not shown and is known per se.

As may be seen, the battery pack 20 comprises a U-shaped battery box 22 with a crosspiece 24 and arms 26, 28. The crosspiece 22 and the arms 26, 28 form a continuous receiving space for a plurality of cells 30. 10 cells 30 are accommodated in the crosspiece space 22 and one respective cell 30 is accommodated in the arms 26, 28. The crosspiece space is reinforced by a transverse wall 32. The spaces between the arms 26, 28 are designed to be slightly larger than the width of the respectively received cell 30. One respective weight 34 and/or 36 is accommodated in the remaining free space.

The remaining space between the aims 26, 28 and the facing crosspiece side is filled up by a housing 38 which receives a charging unit. The housing preferably is the height of the battery box 22, which is dimensioned such that the cells 30 level with a peripheral edge of the battery box 22 are left open, as known per se.

All cells 30 are arranged in series by means of separate electrical connections 40. Their height preferably corresponds to the PzB type, which as known has taller cells than the cells according to PzS which are designed according to the DIN standard.

In order to allow the removal of heat from the charging unit 38, a gap may be provided between the walls of the housing 38 and the walls of the battery box 22 facing said housing, via which air exchange is possible for removing heat. Alternatively, it is also possible to use the battery box itself as a cooling element. In this case, the walls of the charging unit bear directly against the associated walls of the battery box 22 and the battery box has cooling fins or other means for removing the heat produced in the charging unit.

The above disclosure is intended to be illustrative and not exhaustive. This description will suggest many variations and alternatives to one of ordinary skill in this art. All these alternatives and variations are intended to be included within the scope of the claims where the term “comprising” means “including, but not limited to”. Those familiar with the art may recognize other equivalents to the specific embodiments described herein which equivalents are also intended to be encompassed by the claims.

Further, the particular features presented in the dependent claims can be combined with each other in other manners within the scope of the invention such that the invention should be recognized as also specifically directed to other embodiments having any other possible combination of the features of the dependent claims. For instance, for purposes of claim publication, any dependent claim which follows should be taken as alternatively written in a multiple dependent form from all prior claims which possess all antecedents referenced in such dependent claim if such multiple dependent format is an accepted format within the jurisdiction (e.g. each claim depending directly from claim 1 should be alternatively taken as depending from all previous claims). In jurisdictions where multiple dependent claim formats are restricted, the following dependent claims should each be also taken as alternatively written in each singly dependent claim format which creates a dependency from a prior antecedent-possessing claim other than the specific claim listed in such dependent claim below.

This completes the description of the preferred and alternate embodiments of the invention. Those skilled in the art may recognize other equivalents to the specific embodiment described herein which equivalents are intended to be encompassed by the claims attached hereto.

What is claimed is:

1. Battery pack for an industrial truck with an elongate battery box for accommodating a plurality of battery cells, the longitudinal extension thereof extending transversely to the longitudinal axis of the industrial truck, characterized in that the battery box (22) has a U-shape and a housing (38) for a charging unit is arranged between the arms (26, 28) of the U-shaped battery box (22).

2. Battery pack according to claim 1, characterized in that the length of the arms (26, 28) approximately corresponds to the length or width of a battery cell.

3. Battery pack according to claim 1 or 2, characterized in that the crosspiece space of the battery box (22) is twice the width of the battery cells.

4. Battery pack according to claim 1, characterized in that the crosspiece space of the battery box (22) is reinforced by a transverse wall (32).

5. Battery pack according to claim 1, characterized in that the spaces between the arms of the battery box (22) have space for a battery cell (30) and for a weight (34, 36).

6. Battery pack according to claim 1, characterized in that the battery cells (30) ale greater in height than PzS cells.

7. Battery pack according to claim 1, characterized in that the battery box (22) is provided with heat dissipation means.

8. Battery pack according to claim 1, characterized in that the housing (38) of the charging unit may be releasably connected to the battery box (22) and forms a unit therewith.

9. Battery pack according to claim 1, characterized in that the housing (38) of the charging unit is accommodated in a manner which fits approximately between the arms (26, 28) of the battery box (22).
